(19) United States
(12) Patent Application Publication
(10) Pub. No.: US 2026/0078628 A1
(43) Pub. Date: Mar. 19, 2026

(54) SYSTEM FOR MOUNTING BUILDING ELEMENTS

(71) Applicant: VIDA HOLDING AB, Göteborg (SE)

(72) Inventors: Bo STENVALL, Sävedalen (SE); Björn BERGANDER, Torslanda (SE)

(73) Assignee: VIDA HOLDING AB, Göteborg (SE)

(21) Appl. No.: 19/110,205

(22) PCT Filed: Sep. 14, 2023
(86) PCT No.: PCT/SE2023/050898

§ 371 Date: Mar. 10, 2025

(30) Foreign Application Priority Data
Sep. 15, 2022 (SE) 2230292-1

(51) Int. Cl. E06B 3/58; E06B 3/673

(52) U.S. Cl. CPC E06B 3/5871; E06B 3/673

(57) ABSTRACT

Provided is a system for mounting building elements comprising a frame piece and an anchoring device connectable to the frame piece comprising an anchor that can be fixed in the frame piece and a gripper connected to the anchor, wherein the frame piece is designed as a hollow profile formed from a steel sheet by roll forming, and provides a channel formed by bending and dimensioned for insertion of the anchor.

### TECHNICAL FIELD OF THE INVENTION

The present invention relates to a system for mounting building elements of the kind that comprises at least one first and one second mutually plane-parallel building element sheets which are connected to each other by means of a joint placed in the edge areas of the building element comprising a string of compliant and/or elastic material.

### BACKGROUND AND PRIOR ART

Examples of building elements of the current type are multi-layered glass panels intended for installation in window or door openings or for cladding a building. An embodiment of the mounting system is particularly adapted and suitable for mounting glass panels of comparatively greater total thickness, such as glass panels comprising glass sheets of comparatively greater thickness or comprising more than two glass sheets, for example 3- or 4-glazed windows, or glass panels that insulate against cold or heat or glass panels with increased security against burglary.

However, the mounting system according to the present invention is not limited to mounting glass panels, but is also useful for mounting building elements of unspecified material having the general structure as described above.

Earlier examples of similar mounting systems can be found in SE524721 C2 and in SE530870 C2.

Common to the present mounting system and the known equivalents is that they comprise a straight frame piece which is arranged to be attached to a right-sided, typically rectangular, triangular, polygonal or rhomboid-shaped opening in a building wall, whereby a number of frame pieces form a frame encircling the wall opening. Furthermore, the mounting systems include an anchoring device that can be connected to the frame piece comprising an anchor that can be fixed in the frame piece and a gripper pivotably connected to the anchor, which can be brought into engagement with the joint between the building element sheets by pivoting during mounting of the building element in the frame piece, whereby in the connection between anchors and gripper, a mechanical or form-locking latch is arranged to hold the gripper in the engaging position, and where appropriate also effective to hold the gripper removably in the non-engaging position.

In the mentioned known mounting systems, the frame piece is made in the form of an extruded light metal profile, with homogenous cross-section, having a longitudinal channel intended for inserting and receiving the anchor of the anchoring device via an opening to the channel in the upper side of the frame piece. The opening of the channel has inwardly curved edges.

In the known anchoring device, the gripper is connected to the anchor by means of at least one screw which extends through an elastic body consisting of plastic or rubber inserted between the anchor and the gripper. The elastic body is designed so that on the one hand it holds the gripper pivotably from a non-active position and on the other hand effectively fixes the gripper in its active position wherein the gripper engages with a claw in the joint between the building element sheets. In the active position of the gripper, the elastic body exerts a pulling force against the anchor whereby the anchor is lifted into compression against an underside of the inwardly curved edges of the channel opening.

It is an inevitable fact that components made of light metal, such as aluminum, have limited ability to withstand such high temperatures as may occur in a fire. It is another inevitable fact that synthetic materials such as plastic or synthetic rubber compounds exposed to large changes in temperature and humidity and exposed to strong UV radiation may lose some of their elasticity over time. It is understood that, under extreme conditions, this can mean a potential risk of jeopardizing the anchoring of the building element.

### SUMMARY OF THE INVENTION

It is a general aim of the invention to provide an alternative system to the known mounting systems for mounting building elements of the kind mentioned in the introduction above.

In particular, the invention aims to provide a system for mounting building elements that avoids potential risks that may arise under extreme conditions.

A specific aim of the invention is to provide a system for mounting building elements that offers high safety in the event of a fire due to that the components forming the mounting system can withstand high temperature for a longer period of time without losing their operational ability.

These aims are achieved according to the present invention through a system for mounting building elements designed in accordance with patent claim 1. Advantageous embodiments and combinations of components included in the mounting system appear in more detail from subordinate patent claims.

Briefly, according to the invention, a system for mounting building elements is disclosed in which a frame piece is designed as a hollow profile of a uniform cross-sectional shape. The frame piece is roll-formed from a sheet metal blank and has a channel shaped by bending and dimensioned for the insertion of an anchor belonging to an anchoring device.

In a preferred embodiment, the channel comprises two channel walls that run parallel in the longitudinal direction of the hollow profile at a distance from each other and constitute internal support beams standing between the bottom side of the hollow profile and an opposite upper side of the hollow profile.

In this disclosure, the term hollow profile refers to an elongated hollow element with one and the same uniform cross-sectional shape throughout the entire length of the frame piece, whereby the cross-section is defined by a fully enveloping wall of essentially uniform wall thickness, with the exception of wall sections where the material is folded twice, whereby the wall thickness, where applicable, here amounts to the double. The hollow profile is formed by roll forming a sheet metal blank in such a way that the edges of the metal sheet meet and join in a welding joint, so that the hollow profile is closed and has no open wall sections.

Using roll forming technology available on the market, frame pieces according to the invention can be produced continuously from a fed material path and cut to desired lengths.

A frame piece produced by roll forming a sheet metal blank to form a closed hollow profile can be made of metal or metal alloys with high temperature resistance. The frame piece that is part of the new system for mounting building elements is therefore advantageously made of steel or a steel alloy. Particularly preferred is a steel quality that can withstand a fire for at least 30 minutes without the frame piece changing its shape or dimension. By roll forming a steel sheet, the strength of the steel can be combined with low weight of the frame piece. The strength to weight ratio can be maximized by using a high strength steel or an advanced high strength steel (AHSS), which are well suited for roll forming.

A steel-made frame piece produced by roll forming can be applied with various types of rust protection such as painting, electrochemical treatment or embedding in a non-corrosive material, for example, or by polarizing. The corrosion problem can alternatively be avoided by choosing a stainless steel for the production of the frame piece.

In one embodiment of the frame piece, the upper side of the hollow profile has an opening to the channel which is defined by two mutually opposite tongues which are formed by double folding of the sheet metal in an outer radius, which connects to the top of the hollow profile, and an inner radius which connects to the wall of the channel. The inner radius forms a fillet running along the length of the channel, the radius of which can be adapted to the radius of a ridge formed on the anchor which is received in the channel during mounting.

In a preferred embodiment of the frame piece, the channel walls are interconnected through a bottom segment that runs parallel to and next to the bottom of the hollow profile. The bottom segment forms a reinforcement of the bottom of the hollow profile for absorbing compressive forces from stop screws effective to fix one or more anchors in the frame piece in ways that will be explained in more detail below.

In a preferred embodiment of the frame piece, the bottom segment is coupled to the bottom side of the hollow profile at several locations along the length of the hollow profile.

Furthermore, the new system for mounting building elements can include an anchoring device consisting of an anchor that can be fixed in the frame piece and a gripper pivotably connected to the anchor, which, by pivoting, can be brought into engagement with the joint between the building element sheets when mounting the building element in the frame piece. A distinctive feature of this anchoring device is that the anchor, which when inserted in the frame piece is displaceable in the channel of the frame piece, is provided with one or more stop screws which, when tightened, engage with the bottom segment of the channel and impose a force on the anchor directed towards the opening of the channel in the upper side of the hollow profile. In this way, the anchor is locked in the channel by the stop screws lifting the anchor against the above-mentioned tongues in the opening of the channel, with the bottom of the hollow profile and the bottom segment of the channel acting as a counter.

The anchor can be designed as an elongated body with a symmetrical cross-sectional shape and has a greatest width essentially corresponding to the distance between the channel walls of the frame piece.

The anchor can be shaped with an upper side comprising a plane surface that is limited by two parallel running ridges whose curvature is adapted to the radius of the tongue's connection to the nearby channel wall.

The anchor preferably has two uniform sides including a side segment which passes into a bottom surface of the anchor via a radius.

In a preferred embodiment, one or more stop screws are journalled in the anchor which, when tightened, are screwed out from the anchor for engagement with the bottom segment of the channel and which apply a force to the anchor directed towards the tongues in the opening of the channel in the upper side of the hollow profile, with the bottom segment acting as a counter support.

The anchoring device comprises a beam standing on the upper side of the anchor in which the gripper is pivotably supported on a shaft journalled in the beam.

The gripper is mounted in a recess formed in the beam, whereby a cam is formed in the recess which engages in a recess formed on the gripper in the locking position of the gripper.

The frame piece and the anchoring device are preferably made of steel or stainless steel.

Further features and details of preferred embodiments appear below from the detailed description and from subordinate claims.

### BRIEF DESCRIPTION OF THE DRAWINGS

Embodiments of the invention are explained in more detail below with reference to attached drawings, of which

FIG. 1 is a partially broken away perspective view illustrating the assembly of building elements, in this case multilayer glass panels,

FIG. 2 is a cross-section through a frame piece according to known technology, with an anchoring device also of an older and known model,

FIG. 3 is a side view of an anchoring device designed for the new system for mounting building elements,

FIG. 4 is a perspective view of the anchoring device of FIG. 3,

FIG. 5 is a cross-section through a frame piece made as a hollow profile formed by roll forming,

FIG. 6 is a cross-sectional view similar to FIG. 5 showing an alternative frame piece made as a hollow profile formed by roll forming,

FIG. 7 is a view corresponding to FIG. 2 and shows the new mounting system, and

FIG. 8 is a partially broken away side view showing an alternative anchor in a two-part design.

### DETAILED DESCRIPTION OF PREFERRED EMBODIMENTS

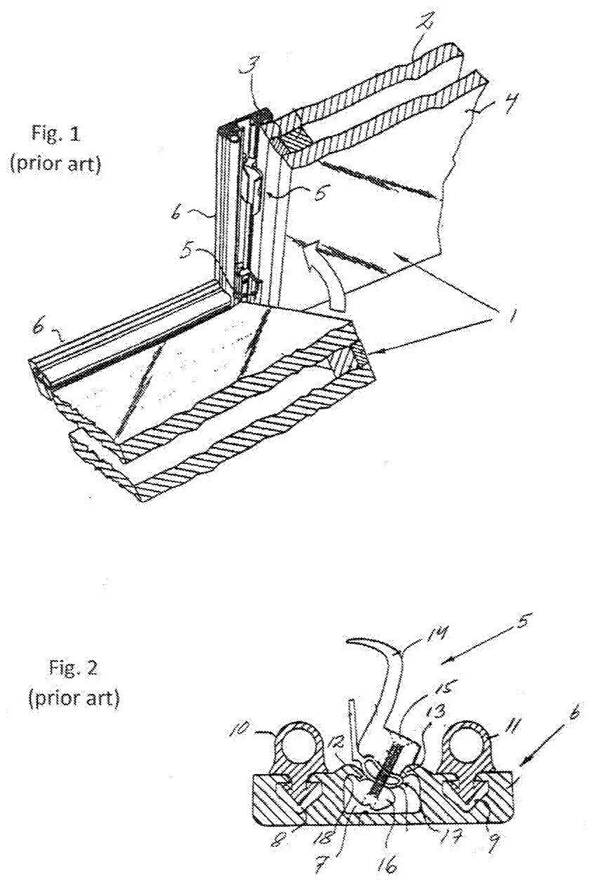

Initially, with reference to FIG. 1, it will be explained how mounting of a building element of the current type is carried out in a manner known per se, by means of the components included in an older system. In the example shown, the building element 1 comprises a first building element sheet 2 which via an elastic and compliant joint 3 is firmly connected to a second building element sheet 4 in a plane-parallel relationship between the sheets 2 and 4. The joint 3 runs along all sides of the building element and is accessible for engagement by a number of claw-shaped anchoring devices 5, which in gripping position hold the building element clamped against a frame piece 6. The frame piece 6 can be mounted in a building structure in a way not shown. It should be noted that the building element in FIG. 1 is shown as a multi-layered glass panel, but it should also be understood that the invention is not limited to building elements containing glass but can be applied to building elements and building element sheets made of other materials such as plastic, plexiglass or glued laminated wood panels (glulam), for example.

The anchoring device 5 and the frame piece 6 shown in FIG. 1 are of an older known model and are explained here in more detail with reference to FIG. 2. The frame piece 6 has a homogeneous or solid cross-section and is produced by extrusion, and is typically made of light metal, such as aluminum. With regard to the orientation of the frame piece in FIG. 2, the frame piece 6 includes an open channel 7 on its upper side and on each side of the channel a respective groove 8 and 9 intended for the mounting of sealing strips 10 and 11. The channel 7 and the grooves 8, 9 run parallel in longitudinal direction of the frame piece. The opening of the channel in the upper side of the frame piece is defined by two mutually opposite and inward-downward directed tongues 12 and 13, respectively, which are used by the anchoring device 5 for fixing the same in the frame piece 6.

The known anchoring device 5 comprises a gripper 14 which is connected via a screw 15 to an anchor 16 that can be inserted into the channel 7. The screw 15 extends through an elastic body 17 inserted between the gripper 14 and the anchor 16. In FIG. 2, the gripper is shown in an inactive position from which the gripper 14 can be swung or pivoted counterclockwise to an active position for engagement in the joint 3 when mounting a building element. During pivoting to the engaging position, the anchor and gripper rotate around a fulcrum 18 formed by the contact of the anchor with the underside of the tongue 12. The elastic body 17 will thereby slide over the tip of the tongue 13 and position itself on the upper side of the tongues 12 and 13 and will thus, via the screw 15, exert a pulling force on the anchor. In this way the known anchoring device 5 is locked in the frame piece by clamping on the tongues 12, 13.

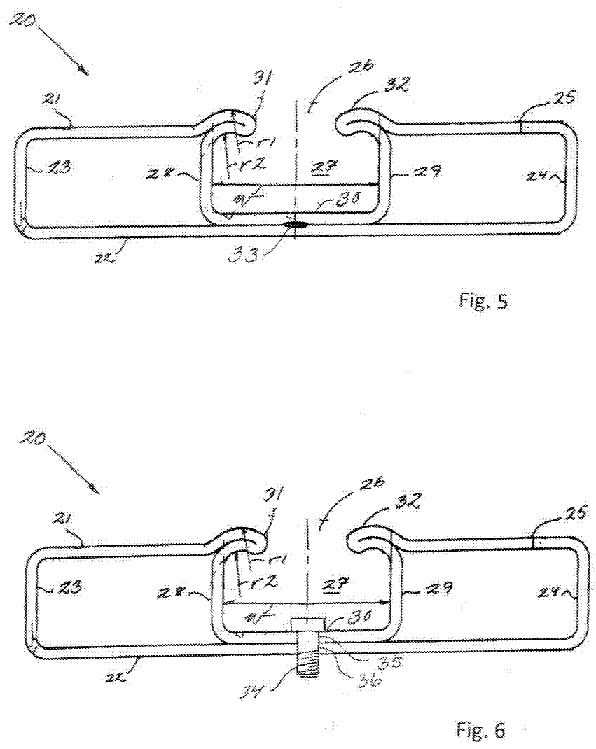

With reference to FIG. 5, the profile of a frame piece 20 included in the new system for mounting building elements is shown in the form of a hollow profile. The frame piece 20 is produced by roll forming a sheet metal blank, preferably a steel sheet blank. With regard to the orientation of the frame piece in FIG. 5, the frame piece 20 comprises an upper side 21 of the hollow profile, a bottom side 22 of the hollow profile, and a left and a right hollow profile side 23 and 24 respectively. The frame piece 20 has a closed profile and is suitably formed from a single metal sheet whose edges are joined in a longitudinal welding joint 25. An opening 26 is formed in the upper side of the hollow profile for a channel 27 formed in the roll forming process, which is defined by a left channel wall 28, a right channel wall 29 and a bottom segment 30 connecting the channel walls.

The channel walls 28 and 29 form vertical support beams running in the length direction of the frame piece. The purpose of the channel walls 28 and 29 is to absorb tensile forces imposed on them when fixing anchoring devices that can be inserted into the channel, and thus prevent the shape of the hollow profile from being affected even if a larger number of anchoring devices, and the corresponding combined tensile forces, were to be applied to a frame piece designed as a hollow profile. In this context, it can be mentioned that the number of anchoring devices can amount to about ten in a frame piece of 1500 mm length with the mounting of building elements on each side of this frame piece.

The opening 26 of the channel is defined by a pair of mutually opposite tongues 31 and 32, which connect to the upper side of the hollow profile through a respective outer radius r1 and to the channel walls 28, 29 through a respective inner radius r2.

In order to increase torsional strength and rigidity of the frame piece 20 formed as a hollow profile, the bottom side 22 and the bottom segment 30 are interconnected and joined together at several locations along the length of the hollow profile. In the embodiment of FIG. 5, a coupling of the bottom segment 30 to the bottom side 22 of the hollow profile is realized through spot welding 33. In the embodiment of FIG. 6, a coupling of the bottom segment 30 to the bottom side 22 of the hollow profile is realized through a bolted connection 34, to which purpose through holes 35, 36 are formed in the bottom segment 30 and in the bottom side 22, respectively. The bolted connection may include a bolt 34 and a fitting nut (not shown), and may alternatively be finalized upon mounting of the hollow profile as the bolt is mated with a bolt hole formed in a supporting structure of a building (not shown). Riveting may be another alternative for coupling of the bottom segment 30 to the bottom side 22 of the hollow profile.

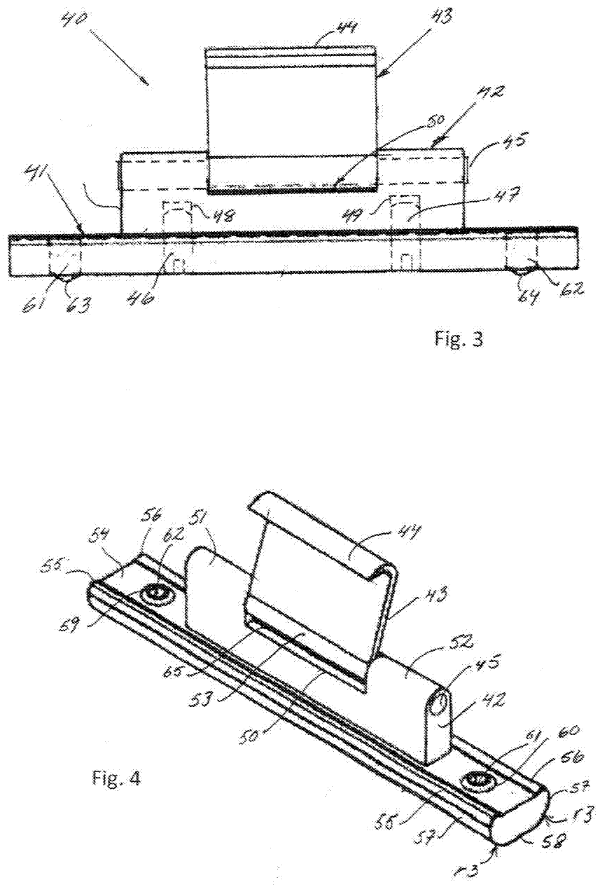

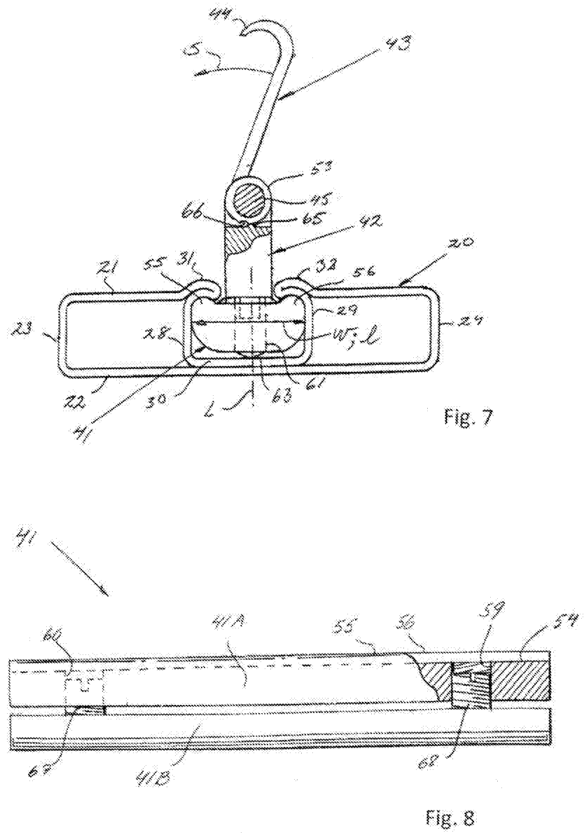

With reference to FIG. 3 and FIG. 4, an anchoring device 40 designed for the new frame piece 20 will now be described. The anchoring device 40 comprises an anchor 41, a beam 42 projecting from the upper side of the anchor and a gripper 43 pivotably journalled in the beam which in its free end is formed into a claw 44. The anchor and the beam are both elongate members, and the gripper is supported on a shaft 45 which is supported in a portion, or in the top, of the beam, facing away from the anchor. The beam 42 has an underside supporting the anchor and in the embodiment is connected to the anchor by means of a pair of screws 46 and 47 which extend up through the anchor to engage in threaded holes 48 and 49 which open into the underside of the beam. Different attachment of the beam is of course possible. A recess 50 is formed in the upper side of the beam for recessed mounting of the gripper 43. The recess 50 is limited at each end by a respective lug 51 and 52 which form bearings for the shaft 45. The gripper has a cylindrical lower end 53 (see also FIG. 7) with a through hole for insertion of the shaft 45 as the gripper is mounted in the recess 50 of the beam 42.

An advantage of a replaceable support for the gripper in the form of a separate beam that can be mounted on the anchor is that the pivot point of the gripper can be adapted to building elements of different thickness by suitable dimensioning of the height of the beam above the anchor.

The upper side of the anchor has a centrally located plane surface 54 which is limited on each side by a curved ridge 55 and a curved ridge 56 respectively, which rise above the plane surface 54 and run in the longitudinal direction of the anchor. The curvature or radius of the ridges is adapted to the inner radius r2 of the tongues 31, 32. The ridge 55 connects to the side of the anchor, which in turn, from a side segment 57, and passes via a radius r3 into a bottom surface 58. The opposite side of the anchor is designed in a corresponding way, whereby the cross-sectional shape of the anchor is symmetrical and identical on each side of a vertical line L passing through the center of the anchor (see FIG. 6). The largest width w of the anchor can be measured between the side segments 57. Essentially the same width I can be measured between the channel walls 28 and 29 in the channel 27 of the frame piece. With the expression “substantially the same width” it is to be understood that the anchor can be slightly narrower than the distance between the channel walls 28 and 29 to facilitate positioning of the anchor in the frame piece during mounting.

A respective threaded hole 59 and 60 opens into the plane surface 54 in the upper side of the anchor. Stop screws 61 and 62 are mounted in the holes 59 and 60 and have such a length that the tips of the screws 63 and 64 are fed out for engagement with the bottom segment 30 of the channel when screwing and locking the anchor in the frame piece 20.

It should here be emphasized that locking the anchor in the frame piece by means of stop screws is an example of embodiment and position fixing or locking of the anchor can be done by means of other locking devices. Alternative forms of locking the anchor are conceivable, such as locking by means of one or more wedges insertable between the anchor and the bottom segment of the channel, for example, or one or more wedges insertable between the anchor and the tongues in the opening area of the channel.

Another alternative embodiment, see FIG. 8, can include a longitudinally divided anchor comprising a top part 41A and a bottom part 41B of essentially the same length with a set screw 67, 68 acting between the top part and the bottom part as through threaded engagement with the top part, to be screwed down in order to press the two parts apart and thereby, with the bottom segment of the channel acting as a counter support, push the anchor against the tongues in the opening area of the channel. By making the anchor with a top part and a bottom part, the parts of the anchor can be introduced separately through the channel opening in axially different positions of the frame piece, and then be united inside the frame piece by being displaced to one and the same axial position where the top part is placed on top of the bottom part. This embodiment provides the advantage that the anchor 41 can be mounted in the frame piece after the frame piece has been mounted in the building structure.

FIG. 7 shows the new anchoring device 40 mounted in the new frame piece 20. Here it can immediately be noted that the locking of the anchoring device in the frame piece according to the new system for mounting building elements differs functionally and constructively from the known older solution. More precisely, the new solution means that the anchor is lifted by the stop screws 61 and 62 to abut against the lower sides of the tongues 31 and 32, while the bottom of the hollow profile 22 and the bottom segment 30 of the channel act as a counter support. Resulting tensile forces are taken up by the channel walls 28 and 29 which ensure that the shape of the channel, and thereby the frame piece, is maintained in the locking position of the anchoring device.

The anchor 41, the beam 42 and the gripper 43 are preferably all made of steel or other heat-resistant metal. By means of the production method which is called precision casting in the industry, these components can also be cast in stainless steel with high dimensional accuracy and high surface finish.

FIG. 7 also shows an example of a latch in the form of a cam 65 formed on the beam 42 which cooperates with a recess 66 formed on the gripper to lock the position of the gripper in the active position. The cam 65 and the recess 66 are examples of a form-locking latch function that sets in when the gripper is swung in the direction of the arrow S shown in the drawing.

In order to achieve the highest possible temperature resistance and fire safety for assembled building elements, fire safety rated materials should of course be chosen in joints between building element sheets, in sealing strips and in existing connections between the frame piece and the building structure. However, these accessories do not form part of the invention and therefore do not need to be described in more detail in order to guide the person skilled in the art in practicing the disclosed new mounting system.

1. A system for mounting building elements, such as building elements comprising at least one first and one second mutually plane-parallel building element sheets which are interconnected by means of a joint placed in edge areas of the building element in the form of a string of compliant and/or elastic material, wherein the mounting system comprises a frame piece and an anchoring device connectable to the frame piece comprising an anchor which can be fixed in the frame piece and a gripper connected to the anchor that can be brought into engagement with the joint when mounting the building element in the frame piece,
wherein the frame piece is designed as a hollow profile, and
wherein the frame piece is roll-formed from a sheet steel blank and provides a channel formed by bending and dimensioned for inserting the anchor wherein the channel has an opening in an upper side of the hollow profile and includes two channel walls running parallel in the longitudinal direction of the frame piece at a mutual distance and providing internal support beams standing between a bottom side of the frame piece and the opposite upper side of the frame piece, wherein the channel walls are designed and effective for absorbing tensile forces, and wherein the channel walls are interconnected by a bottom segment which runs parallel to the bottom side of the hollow profile.

2. A system according to claim 1, wherein the bottom segment is coupled to the bottom side of the hollow profile at several locations along the length of the hollow profile.

3. A system according to claim 1, wherein the opening to the channel is defined by two mutually opposite tongues which are formed by double folding of the steel sheet in an outer radius, which connects to the upper side of the hollow profile, and an inner radius which connects to the nearby channel wall.

4. A system according to claim 1, wherein the anchor is an elongated body with a symmetrical cross-sectional shape and has a largest width substantially corresponding to the distance between the channel walls of the frame piece.

5. A system according to claim 4, wherein the anchor has an upper side comprising a flat surface which is limited by two parallel running ridges whose curvature is adapted to said inner radius of the tongue connection to the nearby channel wall.

6. A system according to claim 4, wherein the anchor has two uniform sides, each comprising a side segment which passes into a bottom surface via a respective radius.

7. A system according to claim 4, wherein the anchoring device comprises a beam standing on the upper side of the anchor in which the gripper is pivotably supported on a shaft journalled in the beam.

8. A system according to claim 7, wherein the gripper is mounted in a recess formed in the beam whereby a cam is formed in the recess which in the locking position of the gripper engages in a groove formed on the gripper.

9. A system according to claim 1, wherein one or more stop screws are supported in the anchor which, when tightened, are screwed out of the anchor for engagement with the bottom segment of the channel and which apply a force to the anchor directed towards the tongues in the channel opening in the upper side of the hollow profile, with the bottom segment acting as a counter support.

10. A system according to claim 1, wherein the anchor consists of a top part and a bottom part and one or more set screws acting between the top part and the bottom part, effective to push the two parts apart upon turning of the screws and thereby apply a force to the anchor directed against the tongues in the channel opening in the top side of the hollow profile, with the bottom segment acting as a counter support.
